(19) United States
(12) Patent Application Publication
(10) Pub. No.: US 2009/0100940 A1
(43) Pub. Date: Apr. 23, 2009

(54) Apparatus For Determining And/Or Monitoring Volume- And/Or Mass-Flow

(75) Inventors: Torsten Strunz, London (GB); Thomas Frohlich, Munchenstein (DE); Achim Wiest, Weil am Rhein (DE); Andreas Berger, Reinach (CH); Oliver Berberig, Grenzach-Wyhlen (DE)

Correspondence Address: BACON & THOMAS, PLLC, 625 SLATERS LANE, FOURTH FLOOR, ALEXANDRIA, VA, 22314-1176, US

(73) Assignee: Endress + Hauser Flowtec AG, Reinach (CH)

(21) Appl. No.: 11/792,628

(22) PCT Filed: Nov. 29, 2005
(86) PCT No.: PCT/EP05/56327

§ 371 Date: Sep. 4, 2008

(30) Foreign Application Priority Data
Dec. 13, 2004 (DE) 10 2004 060 118.6

(51) Int. Cl. G01F 1/66

(52) U.S. Cl. 73/861.28

(57) ABSTRACT

An ultrasonic flow measuring device for determining and/or monitoring volume- and/or mass-flow of a measured medium through a pipeline or measuring tube. The wall of the pipeline or measuring tube is provided, in the region of the defined sensor position of the ultrasonic sensor and/or in the region of the sound path of the ultrasonic measuring signals of the at least one ultrasonic sensor, with a deformation or deformations, which is/are embodied and/or arranged in such a manner that the flow velocity of the medium measured in the sound path, or, in the case of plural ultrasonic sensors, the measured and/or the combined flow velocities of the medium in the sound paths correspond/corresponds at least approximately to average flow velocity of the medium averaged over the area of the pipeline or measuring tube.

The invention relates to an apparatus for determining and/or monitoring volume- and/or mass-flow of a medium through a pipeline or measuring tube, wherein the medium to be measured is flowing essentially in a stream direction parallel to the longitudinal axis of the measuring tube. The apparatus includes: At least one ultrasonic sensor, which transmits and/or receives ultrasonic measuring signals on at least one defined sound path, with the at least one ultrasonic sensor being placed in a defined sensor position in the wall of the measuring tube or on the outer surface of the pipeline; and a control/evaluation unit, which ascertains the volume- and/or mass-flow of the medium through the pipeline, or through the measuring tube, as the case may be, on the basis of the ultrasonic measuring signals. The measured medium can be a liquid, gaseous or vaporous medium.

In inline flow measuring devices, the ultrasonic sensors are installed such that they contact the medium. In this way, in comparison with clamp-on systems, a significantly higher sonic power can be coupled into the medium being measured. In-coupling of a higher sonic power leads to an improved signal-to-noise ratio. The signal-to-noise ratio is defined as the ratio of the wanted signal to the disturbance signal. Here, the wanted signal is defined as that part of the ultrasonic measuring signals which are transmitted via the measured medium. The disturbance signal is represented by that part of the ultrasonic measuring signals which reach the receiver by traveling through the measuring tube.

Usually, the ultrasonic sensors in an inline flow measuring device are positioned in bores in the wall of the measuring tube. The ultrasonic sensors are so secured in the wall of the measuring tube that the integrity of the measuring tube is assured, in any case, under all operating conditions. In order to optimize the ratio of wanted signal to disturbance signal, usually an arrangement is used, in which the ultrasonic sensors are opposite to one another on a direct connecting line. Of course, also an arrangement is possible, in which the ultrasonic measuring signals get from the transmitting ultrasonic sensor to the receiving ultrasonic sensor via a plurality of reflections on the inner wall of the measuring tube.

In the case of inline flow measuring devices, usually used for winning the desired flow information is the travel time, phase- or frequency-difference of ultrasonic measuring signals that pass through the medium, in the direction of flow, and counter to the direction of flow. In order that the influence of the flowing medium on the propagation of the ultrasonic measuring signals be measurable, the ultrasonic sensors must lie on a connecting line other than a perpendicular to the longitudinal axis of the measuring tube.

On the basis of this limitation, an orientation of the ultrasonic sensors results, which is tilted toward the longitudinal axis of the measuring tube. In connection with the desired contact with the medium, the bores are directed through the measuring tube wall; the ultrasonic sensors are subsequently inserted from outside of the tube, into the bores. In order to protect the ultrasonic sensors against abrasion and/or damage, and in order to keep the flow losses as small as possible, usually care is taken, that the ultrasonic sensors do not protrude into the interior of the measuring tube. Due to the resulting ‘sunken’ arrangement of the ultrasonic sensors in the bores, there remain, between the surfaces of the ultrasonic sensors facing the interior of the measuring tube and the inner wall of the measuring tube, cavities, which are filled with the measured medium. Usually, these cavities are referred to as sensor- or fluid-pockets.

It is known that in these cavities flow conditions arise which can, in particular circumstances, considerably influence the measured result. These flow condition changes, which can lead to measured value errors of 10% or more, can occur especially in the laminar flow state (in pipelines, when Re<2300). The accuracy of measurement then rapidly decreases, when the ratio of the diameter of a bore D_{SE} for accommodating an ultrasonic sensor to the inner diameter of the measuring tube D_{M} is greater than about 0.2. In this case, it is found that, upon the subceeding of a predetermined Reynolds number (Re<10,000), the measurement characteristic of an inline flow measuring device becomes nonlinear. A correction of this curve is, up to now, only possible via determination of the current Reynolds number. Ascertainment of Reynolds numbers is well known. For example, U.S. Pat. No. 5,987,997 indicates the possibility of ascertaining Reynolds number via the ratio, or comparison, of averaged velocities measured along different sound paths.

The reason for the non-linear behavior of the measured value errors toward small Reynolds numbers lies in the influencing of the flow in the measuring tube by the aforementioned cavities. It is an intrinsic feature of laminar flows that they cling ever more strongly to the inner wall of the measuring tube as the Reynolds number becomes smaller, i.e. the flow follows every irregularity in the wall. An example of such an irregularity is an aforementioned fluid pocket. Due to the velocity components deviating from the main flow in the region of the ultrasonic sensors, additional kinds of velocities are integrated into the sound path, so that, towards low Reynolds numbers, considerable errors in the measured values occur.

It is a well known problem that, especially in the case of the laminar-turbulent transition of the flows in the measuring tube, eddies occur in the regions of the fluid- or sensor-pockets, and this can likewise negatively affect the linearity of an ultrasonic flow measuring device.

For damping the eddies in the cavities of the measuring tubes of inline flow measuring devices, in U.S. Pat. No. 3,906,791, a screen is so arranged in front of the cavity that it connects flushly with the inner wall of the measuring tube. This insert is acoustically transparent for the ultrasonic measuring signals, due to its special dimensions. Disadvantageous in this solution are the acoustic damping to be expected, or the scattering of the ultrasonic measuring signals, as the case may be, the added manufacturing effort and the danger of plugging of the screen, in the case of dirty fluids.

Additionally in this US patent, a plastic cover-plate/membrane is described for the cavities. Accompanying this cover-plate/membrane, however, is not only a weakening of the wanted signal, but also, in addition, a sound refraction, which is strongly temperature dependent. Also, the proposed, bubble-free filling of the cavity between the ultrasonic sensor and the cover-plate/membrane is very difficult to perform in practice; yet this is required for applications with different static pressures.

In Japanese patent application JP 2003202254 A, a proposal is found, in which the above-described cavities are closed by a kind of aperture. The cavity between the ultrasonic sensor the and aperture is so embodied that laterally directed ultrasonic measuring signals quickly decay. Disadvantageous with this solution is the fact that it results, due to the reduced opening for the sound, in a weakening of the wanted signal. Additionally, also here, in the case of dirty fluids, accretions can lead to plugging. Also, in the case of a flowing liquid, air deposits can form in the area of the cavities, this likewise negatively affecting the strength of the wanted signal.

Instead of a fluid-mechanical solution, in U.S. Pat. No. 5,987,997, a method is described, which aims at a subsequent correction of the measured value error. It is proposed, in particular, to ascertain continuously the Reynolds number of the flowing fluid on the basis of the ratios of velocities, or on the basis of the differences of velocities, along at least two measuring/sound paths differing from one another. This solution is, however, only limitedly usable, since, at the latest, for Re<1000, both the off-center and the central measured value errors run in parallel, as a result of which an unequivocal ascertainment of Reynolds number becomes impossible. Even for larger Reynolds numbers, e.g. Re>3000, the ascertainment is not always unequivocal. Furthermore, in the case of this known method for correction of non-linearities occurring in the case of disturbed flow impingement, significant measured value errors can occur due to incorrect association of the Reynolds number.

An object of the invention is to provide a method for linearizing the measurement characteristic over an expanded range of Reynolds numbers.

The object is achieved by the features that the wall of the pipeline, or measuring tube, as the case may be, is provided, in the region of the defined sensor position of the ultrasonic second and/or in the region of the sound path of the ultrasonic measuring signals of the at least one ultrasonic sensor, with a deformation, or deformations, which is/are embodied and/or arranged in such a manner that the flow velocity of the medium measured in the sound path, or, in the case of a plurality of ultrasonic sensors, the velocities of the medium measured in the sound paths and/or combined with one another, correspond(s), independently of the Reynolds number, at least approximately to the average flow velocity of the medium averaged over the area of the pipeline, or measuring tube, as the case may be.

An essential advantage of the apparatus of the invention is to be seen in the fact that, even in the case of inline flow measuring devices of small nominal diameter (DN15˜DN50) and small Reynolds numbers (Re<10,000), fluid-mechanically related measured value errors caused by hugging of the flow to the measuring tube deformed in the region of the ultrasonic sensors or by eddies of the measured medium in the cavities between the ultrasonic sensors and the inner wall of the measuring tube are minimized.

Other advantages of the solution of the invention include:

No subsequent correction of the measured values (e.g. by means of a correction algorithm) is needed, so that a high robustness is assured vis-a-vis disturbed flow impingements;
there is no weakening of the wanted signal;
no added pressure drop of significance is experienced;
no limitation as regards possible applications needs to be accepted;
when implemented as a cast part, no additional costs arise.

Especially, the deformations involve removed material, i.e. hollowed-out areas, or hollows, respectively depressions, in the wall of the measuring tube. These hollows are so dimensioned that measured value errors are minimized over the desired Reynolds number measuring range either for each individual sound path, or else the minimizing is obtained by a combining of the sound paths, i.e. an offsetting of the characteristics of the individual sound paths against one another.

In a preferred embodiment of the apparatus of the invention, it is provided that the deformations are so embodied essentially in the region between the end of the at least one ultrasonic sensor nearest the inner wall of the measuring tube, and the inner wall of the measuring tube, such that flow components deviating from the stream direction parallel to the longitudinal axis of the measuring tube at least approximately cancel along the measuring path and/or are at least approximately moved out of the measuring path.

Especially, the invention rests on so influencing the flow of the measured medium, by targeted geometric changes/change, respectively deformation/deformations, of the inner wall of the measuring tube in the neighborhood of the cavity filled with medium, such that either the y-velocity components along the sound path of the ultrasonic measuring signals largely sum to zero, or such that the flow regions with y-components relevant for the measuring are so shifted, that they then lie outside of the sound path, or that a combination of these two methods bring-about the desired minimizing of the measured value error.

In a preferred form of embodiment of the apparatus of the invention, the deformation/deformations is/are so embodied that, in the region of the defined sensor position of the ultrasonic sensor and/or in the region of the sound path of the ultrasonic measuring signals of the at least one ultrasonic sensor, no narrow gaps occur. This provides a special advantage as regards avoiding accretions and also provides the possibility of residue-free cleaning of the relevant measuring device region, a matter of special importance in the foods industry.

Additionally, it is provided that the at least one deformation of the wall of the pipeline, or measuring tube, is a depression enlarging the cross section of the pipeline, or measuring tube. However, the deformation can, depending on the form of embodiment, also be an elevation protruding into the interior of the measuring tube.

Especially favorable in connection with the apparatus of the invention has proven to be when the deformation/deformations, respectively depression/depressions, in the wall of the pipeline, or measuring tube, is/are embodied to be gently inclining or gently declining in the stream direction of the medium being measured. By the gentle incline, or gentle decline, flow separation in the case of increasing Reynolds number is prevented, whereby steady flow conditions are assured at the ultrasonic sensors and in the sound path over a very large Reynolds number range.

Seen as especially advantageous in connection with the apparatus of the invention is when a plurality of ultrasonic sensors, which transmit and/or receive ultrasonic measuring signals on different sound paths, are arranged in or at a depression. This serves, on the one hand, for securing the above-mentioned prevention of small gaps, and facilitates, on the other hand, manufacture of the measuring tube, e.g. as a cast part, at small nominal diameters.

In a preferred form of embodiment of the apparatus of the invention, it is provided that at least one ultrasonic sensor is so positioned in a bore and/or is so embodied that it protrudes into the interior of the measuring tube. In this way, it likewise influences the character of the flow of the medium advantageously as regards a linearizing of the measurement characteristic for low Reynolds numbers, or it influences it in connection with at least one deformation located in its vicinity.

As already mentioned above, the flow measuring device can be a clamp-on flow measuring device or an inline flow measuring device. The clamp-on flow measuring device or the inline flow measuring device ascertains the flow velocity of the medium either by a sound entrainment method, especially the travel-time difference principle, or by a Doppler method.

According to an advantageous embodiment of the apparatus of the invention, the measuring tube, respectively the portion of the pipeline carrying the ultrasonic sensor, respectively the ultrasonic sensors, is manufactured as a cast part. The cast part itself can be either of metal or of plastic.

The invention will now be explained in further detail on the basis of the appended drawing, the figures of which show as follows:

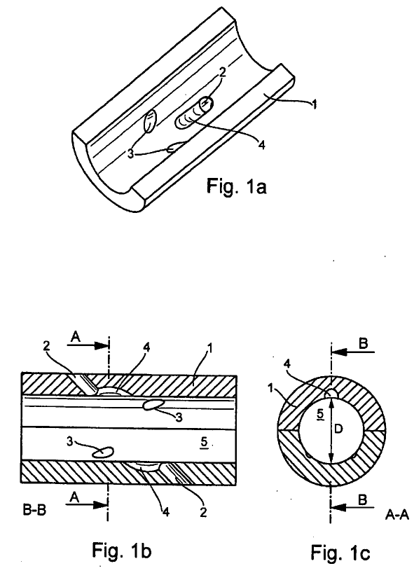

FIG. 1a a perspective view of a cut-open measuring tube of a first embodiment of the apparatus of the invention;

FIG. 1b a longitudinal section taken according to the cutting plane B-B of FIG. 1c;

FIG. 1c a cross section taken according to the cutting plane A-A of FIG. 1b;

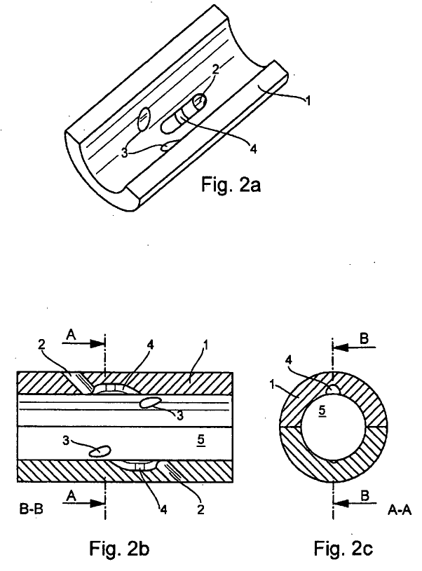

FIG. 2a a perspective view of a cut-open measuring tube of a second embodiment of the apparatus of the invention;

FIG. 2b a longitudinal section taken according to the cutting plane B-B of FIG. 2c;

FIG. 2c a cross section taken according to the cutting plane A-A of FIG. 2b;

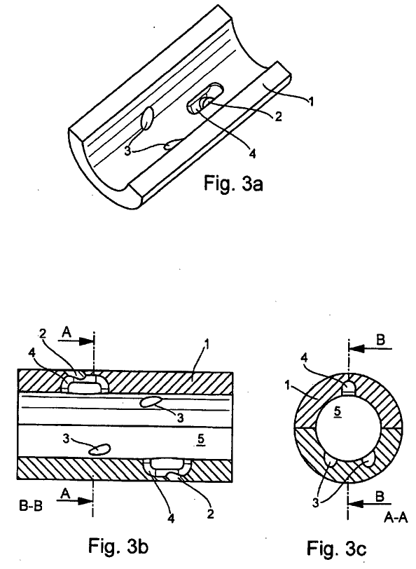

FIG. 3a a perspective view of a cut-open measuring tube of a third embodiment of the apparatus of the invention;

FIG. 3b a longitudinal section taken according to the cutting plane B-B of FIG. 3c;

FIG. 3c a cross section taken according to the cutting plane A-A of FIG. 3b;

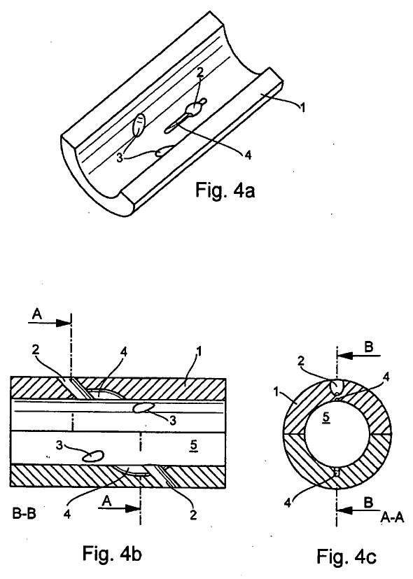

FIG. 4a a perspective view of a cut-open measuring tube of a fourth embodiment of the apparatus of the invention;

FIG. 4b a longitudinal section taken according to the cutting plane B-B of FIG. 4c;

FIG. 4c a cross section taken according to the cutting plane A-A of FIG. 4b;

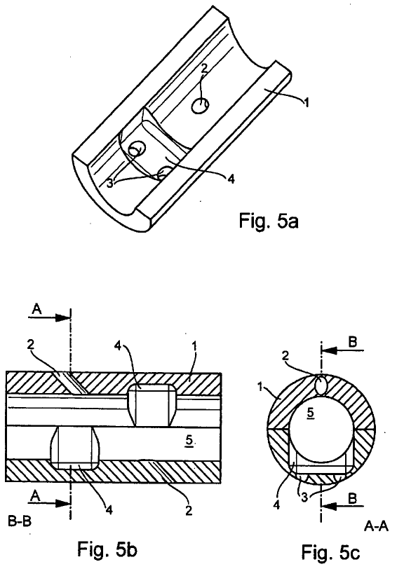

FIG. 5a a perspective view of a cut-open measuring tube of a fifth embodiment of the apparatus of the invention;

FIG. 5b a longitudinal section taken according to the cutting plane B-B of FIG. 5c;

FIG. 5c a cross section taken according to the cutting plane A-A of FIG. 5b;

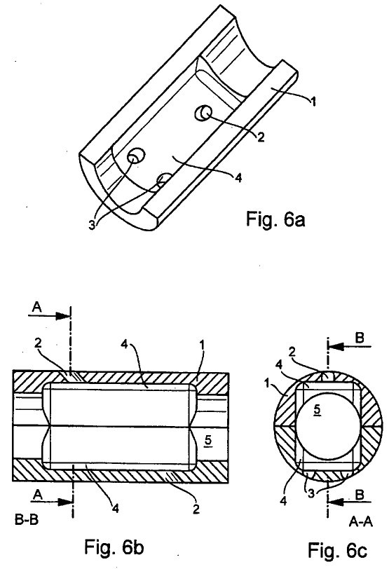

FIG. 6a a perspective view of a cut-open measuring tube of a sixth embodiment of the apparatus of the invention;

FIG. 6b a longitudinal section taken according to the cutting plane B-B of FIG. 6c;

FIG. 6c a cross section taken according to the cutting plane A-A of FIG. 6b;

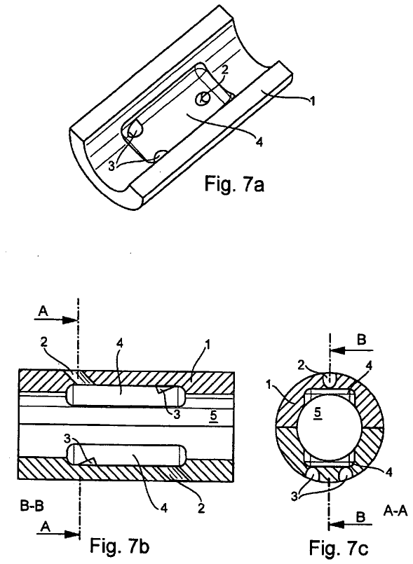

FIG. 7a a perspective view of a cut-open measuring tube of a seventh embodiment of the apparatus of the invention;

FIG. 7b a longitudinal section taken according to the cutting plane B-B of FIG. 7c;

FIG. 7c a cross section taken according to the cutting plane A-A of FIG. 7b;

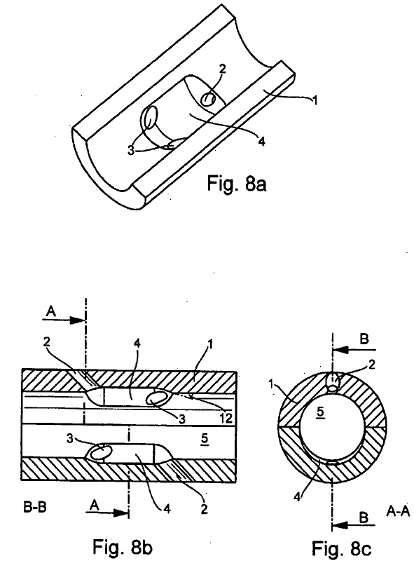

FIG. 8a a perspective view of a cut-open measuring tube of an eighth embodiment of the apparatus of the invention;

FIG. 8b a longitudinal section taken according to the cutting plane B-B of FIG. 8c;

FIG. 8c a cross section taken according to the cutting plane A-A of FIG. 8b;

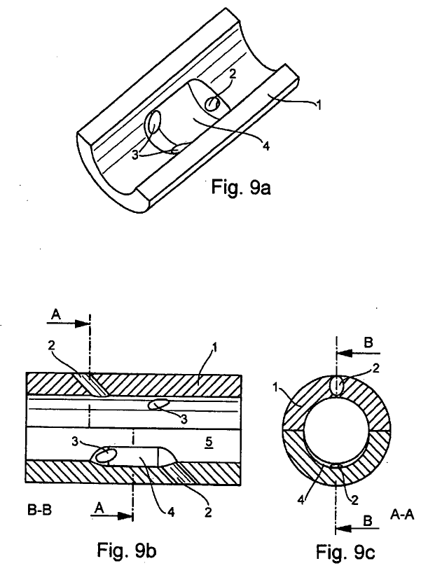

FIG. 9a a perspective view of a cut-open measuring tube of a ninth embodiment of the apparatus of the invention;

FIG. 9b a longitudinal section taken according to the cutting plane B-B of FIG. 9c;

FIG. 9c a cross section taken according to the cutting plane A-A of FIG. 9b;

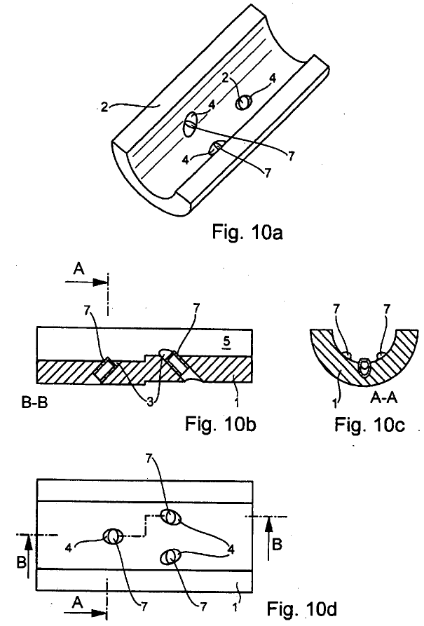

FIG. 10a a perspective view of a cut-open measuring tube of a preferred embodiment of the apparatus of the invention;

FIG. 10b a longitudinal section taken according to the cutting plane B-B of FIG. 10d;

FIG. 10c a cross section taken according to the cutting plane A-A of FIGS. 10b,d;

FIG. 10d a plan view onto the measuring tube as shown in FIG. 10a;

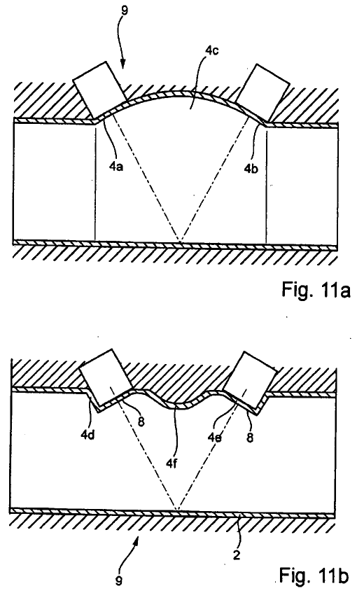

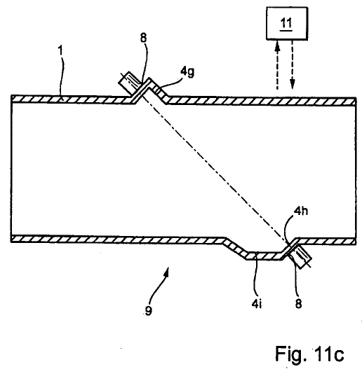

FIG. 11a a schematic representation of a first form of embodiment of the apparatus of the invention embodied as a clamp-on flow measuring device;

FIG. 11b a schematic representation of a second form of embodiment of the apparatus of the invention embodied as a clamp-on flow measuring device;

FIG. 11c a schematic representation of a third form of embodiment of the apparatus of the invention embodied as a clamp-on flow measuring device;

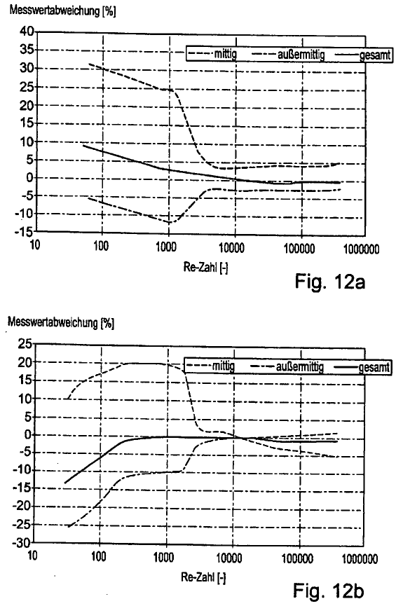

FIG. 12a a schematic representation of the measurement characteristic for a conventional ultrasonic flow measuring device with three sound paths; and

FIG. 12b a schematic representation of the measurement characteristic for an ultrasonic flow measuring device of the invention, with three sound paths.

FIGS. 1 to 9 show schematic representations of nine advantageous embodiments of the inline flow measuring device 10 of the invention. Each of the illustrated flow measuring devices 10 has three measuring channels, or sound paths. Preferably, the ascertaining of the volume- or mass-flow is done using the travel-time difference method. In principle, the invention is, however, applicable to any ultrasonic flow measuring device 9, 10, completely independently of the selected measuring or evaluating method. Although, in the following, exclusively flow measuring devices with at least two ultrasonic sensors are described, actually also an ultrasonic flow measuring device 9, 10 with only one ultrasonic sensor 7, respectively one sound path, can be constructed with the optimized sensor pockets.

FIGS. 1a to 9a show, in each case, a view onto a cut-open measuring tube 1 embodied according to the invention. In each case, three bores 2 are provided with at least partially optimized sensor pockets 4. In the illustrated examples, the deformations 4 are always depressions 4 in the wall of the measuring tube. This has the advantage that, as a result of an enlargement of the diameter D of the measuring tube 1, the danger of plugging is minimized in the measuring tube 1. Of course, from the point of view of optimizing flow, the deformations 4 can also be embodied as elevations. Corresponding examples will be described yet in detail in connection with FIGS. 10, 11.

FIGS. 1b to 9b show, in each case, a longitudinal section taken according to the cutting planes B-B in the FIGS. 1c to 9c. These longitudinal sections show very clearly the shapes of the sensor pocket 4, or sensor pockets 4, as the case may be. FIGS. 1c to 9c show, in each case, a cross section taken according to the cutting plane A-A of FIGS. 1b to 9b.

The individual forms of embodiment presented in FIGS. 1 to 9 differ essentially as regards design of the deformations 4 or sensor pockets 4 and their arrangement and/or structure relative to the ultrasonic sensor/sensors 7.

FIGS. 1 to 4 show embodiments wherein, in each case, a sensor pocket 4 is associated with an ultrasonic sensor 7. In the case of the form of embodiment of the apparatus of the invention shown in FIG. 1, the bore 2 for accommodating an ultrasonic sensor 7 lies in the edge area of the deformation 4. The same is true for the arrangement of the bore 2 for accommodating the ultrasonic sensor 7 in the case of the variant shown in FIG. 2; however, here, the sensor pocket 4 has a greater extent. In the case of the form of invention sketched in FIG. 3, the deformations 4 reach deeper into the inner wall of the measuring tube than in the case of the two previous solutions. In the embodiment shown in FIG. 4, the sensor 7 lies within the sensor pocket 4. Such an embodiment of the deformation to surround the ultrasonic sensor serves, for example, for targeted rinsing of the ultrasonic sensor, to help avoid formation of deposits.

In the case of the variant shown in FIG. 5, two bores 3 are situated in a correspondingly expanded sensor pocket 4. FIGS. 6 and 7 sketch embodiments, in which three bores 2, 3 are placed in a sensor pocket 4.

FIGS. 8 and 9 likewise exhibit three sound paths. FIG. 8 shows a very gently extending rise, respectively fall of the depression 4. As is known, at an angle 12 between the measuring tube wall and depression≦6°, flow separation is avoided at all Reynolds numbers. Consequently, with the help of a deformation 4 satisfying this specification, a constant flow behavior in the region of the sound path over the entire Reynolds number range is achievable, which, in this way, brings with it a linear measurement characteristic independent of Reynolds number.

FIG. 9 shows the same arrangement of sound paths as in FIG. 8, but, here, only one sensor pocket 4 is provided. This makes clear that, for the above described manner in which the deformations 4 of the invention work, already the changing of form in the vicinity of an ultrasonic sensor 7 can be sufficient.

FIG. 10 presents a preferred embodiment of the apparatus of the invention. Here, the deformation/deformations 4 are achieved by components of the sensor pockets 4, with these components protruding into the flow and, in this way, also influencing it. Especially, the components protruding into the flow are the ultrasonic sensors 7 themselves. FIG. 10a is a perspective view onto a cut-open measuring tube 1. FIG. 10b shows a longitudinal section taken according to the cutting plane B-B in FIG. 10d and FIG. 10c sketches a cross section taken according to the cutting plane A-A in FIGS. 10b, 10d. FIG. 10d is a plan view onto the measuring tube 1 in FIG. 10a.

FIG. 11a is a schematic drawing of a first form of embodiment of the apparatus of the invention embodied as a clamp-on flow measuring device 9. In the regions in which the ultrasonic sensors 7 are positionable externally on the wall of the measuring tube 1, the wall of the measuring tube has suitable deformations, here elevations 4a. On the side of the measuring tube 1 on which the two ultrasonic sensors 7 are placed, between the two positioning surfaces 8 for the two ultrasonic sensors 7, is provided a further deformation 4b (in this case, a cross sectional enlargement). This cross sectional enlargement 4b is, in connection with the two hollows 4a, so embodied for the positioning of the ultrasonic sensors 7, that the flow of the medium 5 in the measuring tube 1 is influenced fluid mechanically in the desired manner. The deformations 4a, 4b are of such a character that the flow measuring device 9 has a largely linear behavior over an extended Reynolds number range.

Especially in the case of this first form of embodiment, the diameter D of the measuring tube 1 is enlarged in the region of the sound path of the ultrasonic measuring signals by the three hollows 4a, 4b in the upper region of the measuring tube 1. In this way, no undesirable pressure drop is produced in the measuring tube 1. Additionally, a danger of plugging in the measuring tube 1, especially in the case of small nominal diameters DN and dirty measured medium 5, is lessened.

FIG. 11b is a schematic presentation of a second form of embodiment of the apparatus of the invention embodied as a clamp-on flow measuring device 9. Here, the deformations 4d, 4e, formed as positioning surfaces 8 for the two ultrasonic sensors 7, protrude into the interior of the measuring tube 1. The third deformation 4f, which is an elevation, or bump, of the measuring tube 1, is arranged centrally between the two ultrasonic sensors 7.

FIG. 11c shows a schematic illustration of a third form of embodiment of a clamp-on measuring device 9 with two ultrasonic sensors 7 arranged on oppositely lying sides of the measuring tube 1, or oppositely lying ends of the sound path. The positioning surfaces 8 are located at hollows 4g, 4h of the measuring tube 1. The deformation 4i, likewise enlarging the diameter D of the measuring tube 1, directly adjoins the hollows 4h serving as positioning surface 8 for the lower ultrasonic sensor 7.

[FIG. 12a is a schematic illustration of the measurement characteristic of an ultrasonic flow measuring device 9; 10 of the state of the art, with three sound paths. FIG. 12b is a schematic representation of the measurement characteristic of the ultrasonic flow measuring device 9, 10 of the invention, also with three sound paths. As already described above, in the cavities 4 of the bore 2 between two radiating surfaces of the ultrasonic sensor 7 and the inner wall of the measuring tube 1, flow conditions arise, which influence the measurement characteristic of an ultrasonic flow measuring device 9; 10 non-linearly. In particular, the degradement of the measurement characteristic arises in the case of a laminar flow of the medium 5 in the measuring tube 1 at relatively small nominal diameters DN of the measuring tube 1. Experiments have shown that already a ratio of the diameter D_{SE} of the bore 2 to the inner diameter D_{M} of the measuring tube 1 greater than 0.2 acts disadvantageously on the measurement characteristic of the ultrasonic flow measuring device 9; 10.

In the two FIGS. 12a, 12b, the measurement errors ascertained for two sound-paths (central and off-central), as well as the total measured value error in the two sound paths, are plotted against Reynolds number. In the case of the solution known from the state of the art, without sensor pockets 4 equipped according to the invention, the measured values averaged over all three sound paths become increasingly in error for Re<10,000, i.e. the flow measuring device 9, 10 exhibits, in this Reynolds number range, a non-linear measurement characteristic. A correction of this non-linear measurement characteristic has long been possible only via ascertainment of the current Reynolds number of the measured medium 5 and its adjustment in the signal processing.

The reason for the increase in the measured value errors toward small Reynolds numbers lies in the influencing of the flow of the measured medium 5 in the region of the sensor pockets 4. An essential feature of laminar flows is the property of always clinging more strongly to the wall of the measuring tube 1 as the Reynolds number becomes smaller, i.e. the flow follows the irregularities on the inner wall of the measuring tube ever more strongly. As a result of this, the sensor pockets in the region of the sound path lead to transverse components, which superimpose with the same direction on the main flow components on both sides of the oppositely lying ultrasonic sensors 7, and thus lead to an additional contribution, which makes itself noticeable as an increasing measured value error.

The measurement characteristic of a flow measuring device 9; 10 equipped with optimized sensor pockets 4 and with a small nominal diameter, e.g. DN25, is shown in FIG. 12b. Especially at Re<1000, the illustrated measurement characteristic shows, in comparison to that in FIG. 12a, a clearly different behavior of all three sound paths. Instead of rising, the central measuring path is horizontal down to Re≈100, while the two other sound paths show at Re<400 a decreasing measurement characteristic. Especially worthy of mention is the fact that the transition from a laminar to a turbulent flow profile on all sound paths is recognizable as a marked discontinuity in the measured value error; in contrast, the totaling over all sound paths shows in the case of the optimized sensor pockets 4 a continuous, linear measurement characteristic. Furthermore, the optimized sensor pockets 4 bring about also in the critical transition range, up to Re=10,000 and far beyond, an almost ideally linear measurement characteristic of the flow measuring device 9, 10. In contrast, conventional ultrasonic flow measuring devices usually show for Re≦10,000 already marked measured value errors.

Thus, it is possible, just by use of optimized sensor pockets 4 and by constantly weighted summing of the individual measured values, to implement an ultrasonic flow measuring device 9, 10, which has, within a range Reₘᵢₙ:Reₘₐₓ≧1000, a measurement uncertainty of only ±0.5%. Especially, the linearity assured at Reynolds numbers≧10,000 enables a very broad application spectrum as regards the fluids to be measured. By achieving this characteristic by means of fluid-mechanical optimizing and without subsequent correction of the measured values, there results therefrom a measuring system, which maintains this property even in the case of unfavorable flow impinging conditions. Moreover, the robustness can be further increased by targeted flow-through/rinsing of the ultrasonic sensor measuring locations.

### LIST OF REFERENCE CHARACTERS

1 measuring tube, wall of measuring tube
2 bore
3 bore
4 deformation
5 measured medium
6 longitudinal axis
7 ultrasonic sensor
8 positioning surface
9 clamp-on flow measuring device
10 inline flow measuring device
11 control/evaluation unit
12 angle between measuring tube wall and deformation

1-10. (canceled)

11. An apparatus for determining and/or monitoring volume- and/or mass-flow of a measured medium through a pipeline or a measuring tube, wherein the medium flows through the measuring tube essentially in a stream direction parallel to the longitudinal axis of the measuring tube, comprising:
at least one ultrasonic sensor, which transmits and/or receives ultrasonic measuring signals on at least one defined sound path; said at least one ultrasonic sensor is placed at a defined sensor position in a wall of the measuring tube or on an outer surface of a wall of the pipeline; and
a control/evaluation unit, which ascertains volume- and/or mass-flow of the medium through the pipeline or measuring tube on the basis of the ultrasonic measuring signals, wherein:
the wall of the pipeline or measuring tube has regionally of the defined sensor position of said at least one ultrasonic sensor and/or regionally of the sound path of the ultrasonic measuring signals of said at least one ultrasonic sensor a deformation or deformations, which is/are embodied and/or arranged in such a manner that the flow velocity of the medium measured in the sound path, or, in the case of a plurality of ultrasonic sensors, flow velocities of the medium, measured and/or combined with one another, at least approximately correspond to average flow velocity of the medium averaged over area of the pipeline or measuring tube.

12. The apparatus as claimed in claim 11, wherein:
said deformation or deformations are so embodied that no narrow gaps occur regionally of the defined sensor position of said at least one ultrasonic sensor and/or regionally of the sound path of the ultrasonic measuring signals of said at least one ultrasonic sensor.

13. The apparatus as claimed in claim 11, wherein:
said at least one deformation is a depression in the wall of the pipeline or measuring tube enlarging the cross section of the pipeline or measuring tube.

14. The apparatus as claimed in claim 11, wherein:
said deformation/deformations, or the depression/depressions in the wall of the pipeline or measuring tube is/are gently rising and/or gently falling in the stream direction of the medium.

15. The apparatus as claimed in claim 11, wherein:
a plurality of ultrasonic sensors transmitting and/or receiving ultrasonic measuring signals on different sound paths are arranged regionally of a depression.

16. The apparatus as claimed in claim 11, wherein:
said at least one ultrasonic sensor is so positioned in a bore that it protrudes internally into the measuring tube and influences flow of the medium or influences such in connection with the deformation/deformations.

17. The apparatus as claimed in claim 11, wherein:
the flow measuring device is a clamp-on flow measuring device or an inline flow measuring device.

18. The apparatus as claimed in claim 17, wherein:
said clamp-on flow measuring device or the inline flow measuring device ascertains flow velocity of the medium according to a sound entrainment method or according to a Doppler method.

19. The apparatus as claimed in claim 11, wherein:
the measuring tube or that portion of the pipeline carrying said at least one ultrasonic sensor or ultrasonic sensors is a cast part.

20. The apparatus as claimed in claim 11, wherein:
the pipeline is a line with any cross sectional shape.
